(19) United States
(12) Patent Application Publication
(10) Pub. No.: US 2025/0292241 A1
(43) Pub. Date: Sep. 18, 2025

(54) ONLINE TRANSACTION SYSTEM FOR TRADING SECOND-HAND GOODS

(71) Applicant: Ladies-inlove, Inc., New Taipei City (TW)

(72) Inventors: Hui-Min Chen, New Taipei City (TW); Yu-Wei Tseng, New Taipei City (TW); Ting-An Lin, New Taipei City (TW)

(21) Appl. No.: 18/603,170

(22) Filed: Mar. 12, 2024

(51) Int. Cl. G06Q 20/38; G06Q 20/42

(52) U.S. Cl. CPC G06Q 20/38215; G06Q 20/42; G06Q 2220/00

(57) ABSTRACT

An online transaction system for trading second-hand goods contains: a trading platform module, a digital resume management module, a feature image comparison module, a digital resume certificate module, and a database. The digital resume management module is linked with the trading platform module to establish resumes of the second-hand goods and to acquire characteristic images of the second-hand goods by using an imaging device. The digital resume certificate module is linked between the digital resume management module and the database to produce resume items on a digital resume certificate from the second-hand goods. The feature image comparison module is linked between the digital resume management module and the database. The database is configured to save the digital resume certificate produced by the digital resume certificate module and the characteristic images of the second-hand goods.

### TECHNICAL FIELD

The present invention relates to an online transaction field, and more particularly to the transaction system which is capable of verifying second-hand goods when trading online.

### BACKGROUND

According to a study by the Boston Consulting Group (BCG), the second-hand goods trading market is attracting attention. More and more people are unwilling to buy new products. It mainly echoes the concept of “fashion sustainability” and is also in line with cherishing things, thus ethical consumption concept makes the use of items more sustainable and environmentally friendly. There are hundreds of brands for women, and the second-hand market for men is also expanding. In addition, consumers are gradually beginning to reject “fast fashion” that is fast and of poor quality. Even though there are many commodity trading websites that advertise the sale of second-hand boutiques of well-known designs at ultra-high discounts of 30% off the original retail price, and even include almost unused ultra-new second-hand goods may not necessarily be favored by consumers, since they contain a lot of false information and deception, thus leading to many transaction disputes and distrust among end consumers. Although generally high-quality goods will be accompanied by a certificate or warranty from the original manufacturer after being sold, when the high-quality goods are resold to other people as second-hand goods, even if the seller provides the certificate from the original manufacturer, it is inevitable that the object will be damaged when subcontracting. Because most consumers lack the ability to identify whether an object is authentic, even if they agree to entrust a third party to participate in the verification, it will be time-consuming and expensive. This is also the main reason why many second-hand high-quality trading markets have been unable to promote large-scale business opportunities although they hide huge business opportunities.

There are platforms that participate in the online trading of second-hand goods, aiming to provide a convenient and safe model that protects buyers and sellers during the transaction process. The so-called “security” here refers to the “process” of online platform transactions, so the platform is designed to protect consumers as much as possible and complete transactions in accordance with their wishes and instructions. However, it cannot provide verification to the second-hand goods especially for protecting consumers to acquire the “result” of the second-hand goods by using “instant” verification. Assuming that the second-hand goods are affordable goods, consumers may not be particularly concerned about them, but if they are high-priced products such as well-known brand leather bags, the losses incurred may be difficult to estimate.

The present invention has arisen to mitigate and/or obviate the afore-described disadvantages.

### SUMMARY

The primary aspect of the present invention is to provide an online transaction system for trading second-hand goods which is applied to buy and sell second-hand boutiques so that buyers and sellers in the transaction acquire a digital resume for purchasing reference, and provides “instant verification” of the authenticity of the source and content of the second-hand goods during the delivery process, thus ensuring the security of trading results of the second-hand goods.

Preferably, the online transaction system includes a Consumer To Consumer (C2C) platform and an artificial intelligence (AI) identification technology built so as to accumulate continuous training, identify the authenticity of the second-hand goods, make instant judgments to feed the information back to the trading platform module, thus obtaining online trading safety of the second-hand goods.

To obtain above-mentioned aspect, the online transaction system includes contains provided by the present invention contains: a digital resume management module, a feature image comparison module, a digital resume certificate module, and a database.

The digital resume management module is linked and communicated with the trading platform module to provide identification, a resume creation, an analysis and a management of the second-hand goods which are traded. After receiving the seller's second-hand good information from the trading platform module, it is arranged in advance to pass an appraisal agency to identify and certify whether the second-hand goods are genuine from an original manufacturer, and to record “an item name” which includes but not limited to the second-hand good, “a brand name”, “a factory information (such as information on the purchase certificate)”, “a certification date”, “a characteristic description (including scratches, old marks . . . etc.)”, “a certification result” and other resume items by using the digital resume management module. In the meantime, an imaging device is configured to obtain “characteristic images” of the second-hand goods from different angles by using technologies which include but not limited to photography, and scanning, etc., thus certifying the second-hand goods.

The digital resume certificate module is linked between the digital resume management module and the database so as to produce the resume item on a digital resume certificate from “the item name”, “the brand name”, “the factory information (such as the information on the purchase certificate)”, “the certification date”, “the characteristic description (including the scratches, and the old marks . . . etc.)”, and “the certification result” recorded by the digital resume management module. The digital resume certificate includes a unique digital code configured to be paired with “the characteristic images” selected from the second-hand goods and to be saved in the database.

The feature image comparison module is linked between the digital resume management module and the database, and the feature image comparison module includes artificial intelligence (AI) identification technology built therein to identify the “the feature images” of the second-hand goods saved in the database.

The database is configured to save the digital resume certificate produced by the digital resume certificate module and the characteristic images of the second-hand goods, to provide saved information to the digital resume certificate module and the characteristic image comparison module so as to amend resumes of the digital resume certificate, and to compare with the characteristic images of the second-hand goods.

The buyer which holds the second-hand goods also owns a digital purchased resume certificate with the unique digital code. When desiring to resell the second-hand goods to a third party by the buyer, the second-hand goods are delivered a third party for an inspection, and the authenticity and history of the second-hand goods are checked in advance by using the online transaction system. Thereby, an original buyer (i.e. a current seller) of the second-hand goods or the holder of the second-hand goods who has delivered the second-hand goods to the third party (i.e. a current buyer) is capable of entering the trading platform module of the online transaction system to operate the trading. For example, inputting the unique digital code of the digital resume certificate to confirm whether the second-hand goods come from the online transaction system. After passing a confirmation, “the characteristic images” of the second-hand goods are captured from all angles and uploaded based on requirements of the digital resume management module. Then, the characteristic image comparison module compares “inputted feature images” with “the feature images” saved in the database to confirm whether “the inputted feature images” are consistent with “the feature images” of the database. When “the inputted feature images” are consistent with “the feature images” of the database, the digital resume management module sends the comparison result to the trading platform module and feedbacks the comparison result to the user (i.e., the current seller or the holder of the second-hand goods who has delivered the second-hand goods to the current buyer) to certify the source and the resume of the second-hand goods. When “the inputted feature images” are inconsistent with “the feature images” of the database by using the feature image comparison module, the digital resume management module requests the user to re-input or re-capture “the characteristic images” from all angles of the second-hand goods for re-comparison to prevent the seller from delivering false second-hand goods to the buyer. Alternatively, the trading platform module provides the buyer an “instant” verification mechanism to confirm the authenticity of the second-hand goods after the buyer receives the second-hand goods, thus protecting the buyer's rights.

### BRIEF DESCRIPTION OF THE DRAWINGS

FIG. 1 is a schematic view of an online transaction system for trading second-hand goods according to a preferred embodiment of the present invention.

FIG. 2 is a schematic view of a digital resume certificate according to the preferred embodiment of the present invention.

FIG. 3 is a flow chart showing a holder of the second-hand goods to verify the authenticity of the second-hand goods through the online trading system 1 according to the preferred embodiment of the present invention.

### DETAILED DESCRIPTION

The present invention relates to an online transaction system for trading second-hand goods, and more particularly to buy and sell second-hand boutiques so that buyers and sellers in the transaction acquire the verification and history provided by the online transaction system to identify an authenticity, thus ensuring a sale of the second-hand goods. Thereby, the rights and interests of both parties (i.e. the buyers and sellers) are traded online to avoid unnecessary disputes in future.

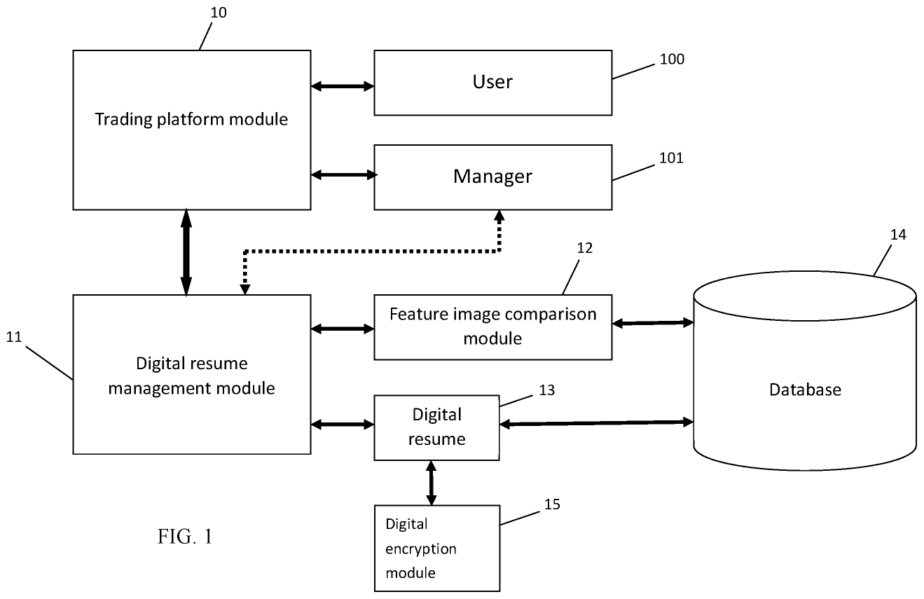

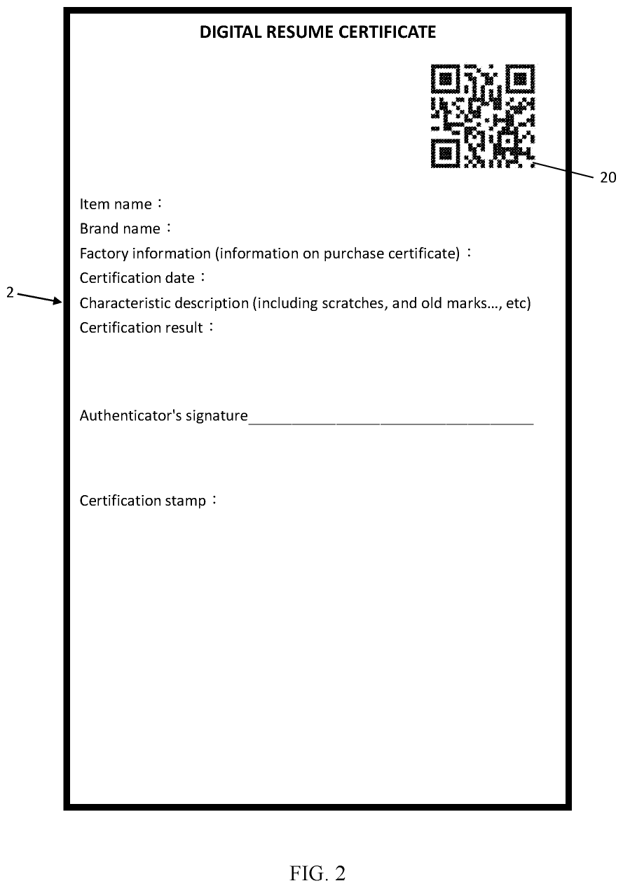

Referring to FIGS. 1 and 2, the online transaction system 1 comprises a trading platform module 10, a digital resume management module 11, a feature image comparison module 12, a digital resume certificate module 13, and a database 14, such that these modules are linked to have a two-way communication for information and data, thus forming the online transaction system 1.

In this embodiment, the trading platform module 10 is but not limited to a Consumer To Consumer (C2C) platform so as to provide trading services to a user 100. In other words, customers (i.e. the buyers and sellers) have a trading online, and a manager provides the trading services and maintains the online transaction system.

The digital resume management module 11 is linked and communicated with the trading platform module 10 to provide identification, a resume creation, an analysis and a management of the second-hand goods which are traded. After receiving the seller's second-hand good information from the trading platform module 10, it is arranged in advance to pass an appraisal agency to identify and certify whether the second-hand goods are genuine from an original manufacturer, and to record “an item name” which includes but not limited to the second-hand good, “a brand name”, “a factory information (such as information on the purchase certificate)”, “a certification date”, “a characteristic description (including scratches, old marks . . . etc.)”, “a certification result” and other resume items by using the digital resume management module 11. In the meantime, an imaging device is configured to obtain “characteristic images” of the second-hand goods from different angles by using technologies which include but not limited to photography, and scanning, etc., thus certifying the second-hand goods.

The digital resume certificate module 13 is linked between the digital resume management module 11 and the database 14 so as to produce the resume item on a digital resume certificate 2 from “the item name”, “the brand name”, “the factory information (such as the information on the purchase certificate)”, “the certification date”, “the characteristic description (including the scratches, and the old marks . . . etc.)”, and “the certification result” recorded by the digital resume management module 11. As shown in FIG. 2, the digital resume certificate 2 includes a unique digital code 20 configured to be paired with “the characteristic images” selected from the second-hand goods and to be saved in the database 14, wherein the unique digital code 20 is but not limited to a Quick Response Code (QR code) as shown in FIG. 2. Preferably, the digital resume certificate module 13 is also linked to a digital encryption module 15 by which the digital resume certificate 2 is encrypted to prevent from being tampered with or stolen without using permission.

The feature image comparison module 12 is linked between the digital resume management module 11 and the database 14, wherein the feature image comparison module 12 includes artificial intelligence (AI) identification technology built therein to identify whether the “the feature images” of the second-hand goods saved in the database 14 match information provided by the user/holder 100.

The database 14 is configured to save the digital resume certificate 2 produced by the digital resume certificate module 13 and the characteristic images of the second-hand goods, to provide saved information to the digital resume certificate module 13 and the characteristic image comparison module 12 so as to amend resumes of the digital resume certificate 2, and to compare with the characteristic images of the second-hand goods.

When conducting the trading, the sellers of the second-hand goods send the item to a manager 101 of the online transaction system 1 so that the manager 101 arranges an appraisal institution in advance to identify the authenticity of the item and to record “the item name”, “the brand name”, “the factory information (such as the information on the purchase certificate)”, “the certification date”, “the characteristic description (including the scratches, the old marks . . . etc.)”, and “the certification result” by using the digital resume management module 11. Also, the imaging device obtains “the characteristic images” of the second-hand goods from different angles by using the technologies including but not limited to the photography, and the scanning, etc., thus certifying the second-hand goods. Thereafter, these information and data are sent to the digital resume certificate module 13 to generate the digital resume certificate 2 as shown in FIG. 2, and the unique digital code 20 is formulated on the digital resume certificate 2 so as to match the unique digital code 20 with “the feature images” and to save the digital resume certificate 2 in the database 14.

When the user 100 of the buyer selects the items on the trading platform module 10, he/she previews the items recorded on the digital resume certificate 2 as a purchasing reference so as to fully understand an actual condition of the second-hand goods. After confirming a purchase process, the trading platform module 10 sends the digital resume certificate 2 encrypted to the buyer, thus producing a purchasing guarantee.

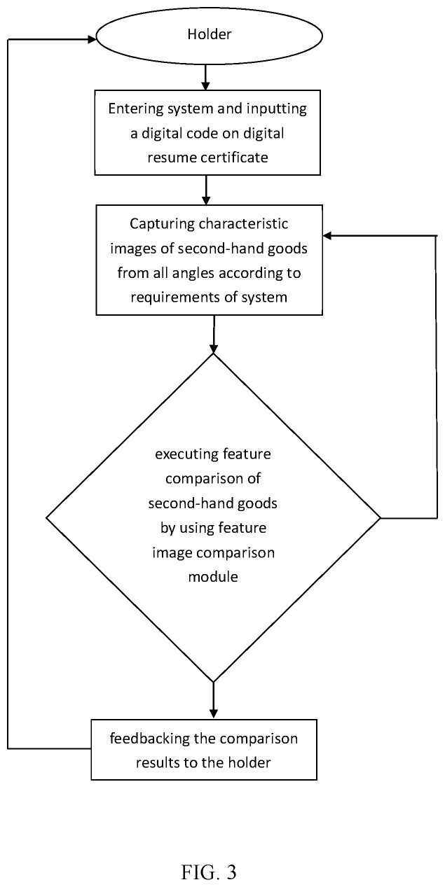

The buyer which holds the second-hand goods also owns a digital purchased resume certificate 2 with the unique digital code 20. When desiring to resell the second-hand goods to a third party by the buyer, the second-hand goods are delivered a third party for an inspection, and the authenticity and history of the second-hand goods are checked in advance by using the online transaction system 1. FIG. 3 is a flow chart showing a holder of the second-hand goods to verify the authenticity of the second-hand goods through the online trading system 1. Thereby, an original buyer (i.e. a current seller) of the second-hand goods or the holder of the second-hand goods who has delivered the second-hand goods to the third party (i.e. a current buyer) is capable of entering the trading platform module 10 of the online transaction system 1 to operate the trading. For example, inputting the unique digital code 20 of the digital resume certificate 2 to confirm whether the second-hand goods come from the online transaction system 1. After passing a confirmation, “the characteristic images” of the second-hand goods are captured from all angles and uploaded based on requirements of the digital resume management module 11. Then, the characteristic image comparison module 12 compares “inputted feature images” with “the feature images” saved in the database 14 to confirm whether “the inputted feature images” are consistent with “the feature images” of the database 14. When “the inputted feature images” are consistent with “the feature images” of the database 14, the digital resume management module 11 sends the comparison result to the trading platform module 10 and feedbacks the comparison result to the user 100 (i.e., the current seller or the holder of the second-hand goods who has delivered the second-hand goods to the current buyer) to certify the source and the resume of the second-hand goods. When “the inputted feature images” are inconsistent with “the feature images” of the database 14 by using the feature image comparison module 12, the digital resume management module 11 requests the user 100 to re-input or re-capture “the characteristic images” from all angles of the second-hand goods for re-comparison to prevent the seller from delivering false second-hand goods to the buyer. Alternatively, the trading platform module 10 provides the buyer a verification mechanism to confirm the authenticity of the second-hand goods after the buyer receives the second-hand goods, thus protecting the buyer's rights.

Different styles of second-hand goods have different selected parts and angles for “the feature images”, so built-in artificial intelligence (AI) recognition technology of the feature image comparison module 12 requires long-term established specifications to execute machine learning. Taking leather bags of Hermès and Chanel for examples, selectable feature images are described as follows:

A) When trading the leather bag of Hermes, a selection of the characteristic image of the item includes but not limited to: a metal and a lettering of ears, a depth of the lettering, a type of the lettering, a thickness of the metal, a brightness of the metal and a metal material of Hermès, and workmanship with four screws on the metal of the Hermès logo, etc. Also, films on the Hermès logo are all not counterfeited. In addition, glue on the leather bag is also used as a feature of the leather bag of Hermès. Hermès has inner codes with stars, horseshoes, numbers, and boxes, etc. Among them, 2021 starts with Y and Z, then numbers are added to form the inner codes, and stitching of the leather bag of Hermès is manually sewn by a master.

B) When trading the leather bag of Chanel, a selection of the characteristic image of the item includes a front surface, multiple sides, and a back surface of the leather bag of Chanel, wherein the leather bags of Chanel in the same style and color have different characteristic images. Furthermore, internal codes, numbers of the internal codes of the leather bag of Chanel are different, so thicknesses, fonts, and colors of lettering of the internal codes are a key to the characteristics of the leather bag of Chanel.

Accordingly, the feature image comparison module 12 includes the AI identification technology built therein to immediately identify whether “the feature image” of the second-hand goods saved in the database 14 match the information inputted by the buyer after executing a deep learning, thus obtaining online trading safety of the second-hand goods by using the online transaction system.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. An online transaction system for trading second-hand goods being applied to buy and sell second-hand goods, and the online transaction system comprising: a trading platform module, a digital resume management module, a feature image comparison module, a digital resume certificate module, and a database, such that the modules are linked to have a two-way communication for information and data;
wherein the digital resume management module is linked and communicated with the trading platform module to establish resumes of the second-hand goods and to acquire characteristic images of the second-hand goods by using an imaging device;
wherein the digital resume certificate module is linked between the digital resume management module and the database so as to produce resume items on a digital resume certificate from the second-hand goods, and the digital resume certificate includes a unique digital code configured to be paired with the characteristic images selected from the second-hand goods and to be saved in the database;
wherein the feature image comparison module is linked between the digital resume management module and the database, and the feature image comparison module includes artificial intelligence (AI) identification technology built therein to identify whether the “feature images” of the second-hand goods saved in the database match information provided by a holder;
wherein the database is configured to save the digital resume certificate produced by the digital resume certificate module and the characteristic images of the second-hand goods;
wherein the unique digital code of the digital resume certificate is inputted into the online transaction system by the holder so as to confirm whether the second-hand goods come from the online transaction system; after passing a confirmation, “the characteristic images” of the second-hand goods are captured from all angles and uploaded based on requirements of the digital resume management module; then the characteristic image comparison module compares “inputted feature images” with “the feature images” saved in the database to confirm whether “the inputted feature images” are consistent with “the feature images” of the database.

2. The online transaction system as claimed in claim 1, wherein the unique digital code of the digital resume certificate is a Quick Response Code (QR code).

3. The online transaction system as claimed in claim 1, wherein when “the inputted feature images” are consistent with “the feature images” of the database, the digital resume management module sends a comparison result to the trading platform module and feedbacks the comparison result to the user; when “the inputted feature images” are inconsistent with “the feature images” of the database by using the feature image comparison module, the digital resume management module requests the user to re-input or re-capture “the characteristic images” from all angles of the second-hand goods for re-comparison.

4. The online transaction system as claimed in claim 1, wherein the digital resume certificate records an item name which includes a factory information, a certification date, a characteristic description, and a certification result of the second-hand goods.

5. The online transaction system as claimed in claim 1, wherein the digital resume certificate module is linked with a digital encryption module so that the digital resume certificate is encrypted by the digital encryption module.

6. The online transaction system as claimed in claim 2, wherein the digital resume certificate module is linked with a digital encryption module so that the digital resume certificate is encrypted by the digital encryption module.

7. The online transaction system as claimed in claim 3, wherein the digital resume certificate module is linked with a digital encryption module so that the digital resume certificate is encrypted by the digital encryption module.

8. The online transaction system as claimed in claim 4, wherein the digital resume certificate module is linked with a digital encryption module so that the digital resume certificate is encrypted by the digital encryption module.
